(19) United States
(12) Patent Application Publication
(10) Pub. No.: US 2020/0118013 A1
(43) Pub. Date: Apr. 16, 2020

(54) ABDUCTIVE INFERENCE APPARATUS, ABDUCTIVE INFERENCE METHOD, AND COMPUTER-READABLE RECORDING MEDIUM

(71) Applicant: NEC CORPORATION, Tokyo (JP)

(72) Inventor: Kazeto YAMAMOTO, Tokyo (JP)

(73) Assignee: NEC CORPORATION, Tokyo (JP)

(21) Appl. No.: 16/622,105

(22) PCT Filed: Jun. 13, 2017
(86) PCT No.: PCT/JP2017/021863

§ 371 Date: Dec. 12, 2019

(51) Int. Cl. G06N 5/04

(52) U.S. Cl. CPC G06N 5/041; G06N 5/045; G06N 5/046; G06N 5/042

(57) ABSTRACT

A abductive inference apparatus (1) includes a candidate hypothesis generation unit (2) configured to apply, to an observation that indicates an observed situation using a logical expression, inference knowledge provided with the reliability for making a forward inference and the reliability for making a reverse inference, make an inference, and generate a candidate hypothesis by which the observation can be derived; and a candidate hypothesis evaluation unit (3) configured to specify an inference direction for each piece of the inference knowledge applied to the generated candidate hypothesis, and calculate an evaluation value of the candidate hypothesis using the reliability of each piece of the inference knowledge that corresponds to the specified inference direction.

### TECHNICAL FIELD

The invention relates to an abductive inference apparatus and an abductive inference method for making an abductive inference, and further relates to a computer-readable recording medium having recorded thereon a program for realizing the apparatus and the method.

### BACKGROUND ART

Abductive inference is an inference method for deriving a hypothesis that explains observed facts based on known knowledge, and has been performed for a long time. Recently, abductive inference is performed using a calculator due to dramatic increases in processing speed (e.g., see Non-Patent Document 1).

Non-Patent Document 1 discloses an example of an abductive inference method using a calculator. In Non-Patent Document 1, an abductive inference is made using candidate hypothesis generation means and candidate hypothesis evaluation means. Specifically, candidate hypothesis generation means generate a set of candidate hypotheses using, as inputs, an observation and a knowledge base (Background knowledge). An observation is a conjunction of first-ordered literals. By evaluating the probability of each candidate hypothesis, the candidate hypothesis evaluation means selects, from the set of generated candidate hypotheses, a candidate hypothesis that can explain the observation without excess or deficiency, that is, the best candidate hypothesis (the best hypothesis, solution hypothesis), as an explanation of the observation, and outputs the selected best candidate hypothesis.

Also, usually, in many existing abductive inferences, observations are provided with parameters (costs) indicating “which piece of observation information is important”. Inference knowledge is stored in the knowledge base, and each piece of inference knowledge (axiom) is provided with a parameter (weight) indicating “the reliability of the antecedent holding true when the consequent holds true”. Also, evaluation values (Evaluation) are calculated in consideration of these parameters in the evaluation of the probability of a candidate hypothesis.

Abductive inference disclosed in Non-Patent Document 1 will be described using specific examples. Assume that a logical formula that indicates the information “Criminal A and Police officer B are present, and these two people are in the same police car” is given as an observation, for example. Also, the knowledge base includes, as inference knowledge, pieces of knowledge, such as “if x arrests y, then x is a police officer and y is a criminal”, “an arrested person gets in a police car”, and “a police officer gets in a police car”.

In this case, the candidate hypothesis generation means determines whether each piece of inference knowledge can be applied in reverse to the observation. In the above-described specific example, only the inference knowledge “if x arrests y, then x is a police officer and y is a criminal” is applicable. Thus, as shown in FIG. 7, the candidate hypothesis generation means generates “Police officer B arrested Criminal A” as a candidate hypothesis. Also, the candidate hypothesis generation means selects “Police officer B arrested Criminal A” as a candidate hypothesis. FIG. 7 is a diagram showing an example of candidate hypotheses generated using a conventional method.

In this manner, according to the abductive inference method disclosed in Non-Patent Document 1, the candidate hypothesis “Police officer B arrested Criminal A” is selected in the above-described specific example, and thus all pieces of observation information are deductively derived from the hypothesis using the background knowledge. That is, the observation can be explained by the candidate hypothesis “Police officer B arrested Criminal A” without excess or deficiency.

### LIST OF RELATED ART DOCUMENTS

### Non Patent Document

Non-Patent Document 1: Naoya Inoue and Kentaro Inui, “ILP-based Reasoning for Weighted Abduction”, In Proceedings of AAAI Workshop on Plan, Activity and Intent

### SUMMARY OF INVENTION

### Problems to be Solved by the Invention

However, the above-described abductive inference method disclosed in Non-Patent Document 1 has two issues. Hereinafter, the two issues will be described in detail.

The first issue is that, with the abductive inference method disclosed in Non-Patent Document 1, only a reverse inference can be made for an observation, and appropriate candidate hypotheses cannot be selected in some cases.

Assume that there is an observation that indicates the information “Robber A and Police officer B are present, and these two people are in the same police car”, for example. Also, assume that an explanation thereof is generated using pieces of inference knowledge, such as “a robber is a criminal”, “if x arrests y, then x is a police officer and y is a criminal”, “an arrested person gets in a police car”, and “a police officer gets in a police car”. In this case, it is conceivable that a candidate hypothesis made by using an observation is most likely to be explainable without excess or deficiency is “Police officer B arrests Robber A”.

Note that, in order to select this candidate hypothesis, the logical formula “criminal(A)” included in the candidate hypothesis needs to be derived, and the forward inference “a robber is a criminal” needs to be applied to the observation. Thus, with the above-described abductive inference method disclosed in Non-Patent Document 1, the candidate hypothesis “Police officer B arrests Robber A” is not included in the set of candidate hypotheses, and is not output as a solution hypothesis.

The second issue is that, when knowledge such as “a bird flies”, which does not necessarily always hold true, is given to a system as inference knowledge, for example, the probability of a candidate hypothesis that is generated using this knowledge cannot be appropriately evaluated.

The reason therefor is that, with the above-described abductive inference method disclosed in Non-Patent Document 1, the candidate hypothesis evaluation means evaluates candidate hypotheses based on the premise that each piece of inference knowledge is logically true. That is, the reason therefor is that, with the above-described abductive inference method disclosed in Non-Patent Document 1, for each piece of inference knowledge, the premise is that, if the logical formula of the antecedent holds true, then the logical formula of the consequent also holds true.

Thus, the candidate hypothesis evaluation means cannot appropriately evaluate candidate hypotheses generated using inference knowledge that does not satisfy this premise, and there is a possibility that a candidate hypothesis that is inappropriate as an explanation of the observation will be output as a solution hypothesis. There are many situations in practical use where use of inference knowledge that does not satisfy this premise, that is, “inference knowledge that holds true in many cases, but there are also cases where the inference knowledge does not hold true” is desired. Thus, the second issue needs to be resolved.

Note that, in order to resolve the first issue, there are cases where measures are taken to express a pseudo-forward inference by applying a reverse inference using inference knowledge in which the antecedent and the consequent of inference knowledge are reversed. However, in these cases, the second issue regarding the evaluation of a hypothesis still remains unresolved. This is because the inference knowledge in which the antecedent and the consequent are reversed corresponds, in most cases, to inference knowledge that does not satisfy the above-described premise, that is, inference knowledge that holds true in many cases, but does not always hold true.

An example object of the invention is to provide an abductive inference apparatus, an abductive inference method, and a computer-readable recording medium that can resolve the above-described issues, make a forward inference, and evaluate the probability of a candidate hypothesis as appropriate even if inference knowledge that does not always hold true is used.

### Means for Solving the Problems

In order to achieve the above-described object, an abductive inference apparatus according to an example aspect of the invention includes:
a candidate hypothesis generation unit configured to apply, to an observation that indicates an observed situation using a logical expression, inference knowledge provided with reliability for making a forward inference and reliability for making a reverse inference, make an inference, and generate a candidate hypothesis by which the observation can be derived; and
a candidate hypothesis evaluation unit configured to specify an inference direction for each piece of the inference knowledge applied to the generated candidate hypothesis, and calculate an evaluation value of the candidate hypothesis using the reliability of each piece of the inference knowledge that corresponds to the specified inference direction.

Also, in order to achieve the above-described object, an abductive inference method according to an example aspect of the invention includes:
(a) a step of applying, to an observation that indicates an observed situation using a logical expression, inference knowledge provided with reliability for making a forward inference and reliability for making a reverse inference, making an inference, and generating a candidate hypothesis by which the observation can be derived; and
(b) a step of specifying an inference direction for each piece of the inference knowledge applied to the generated candidate hypothesis, and calculating an evaluation value of the candidate hypothesis using the reliability of each piece of the inference knowledge that corresponds to the specified inference direction.

Also, in order to achieve the above-described object, a computer readable recording medium includes a program recorded thereon, the program including instructions that cause a computer to carry out:
(a) a step of applying, to an observation that indicates an observed situation using a logical expression, inference knowledge provided with reliability for making a forward inference and reliability for making a reverse inference, making an inference, and generating a candidate hypothesis by which the observation can be derived; and
(b) a step of specifying an inference direction for each piece of the inference knowledge applied to the generated candidate hypothesis, and calculating an evaluation value of the candidate hypothesis using the reliability of each piece of the inference knowledge that corresponds to the specified inference direction.

### Advantageous Effects of the Invention

As described above, according to the invention, a forward inference can be made, and the probability of a candidate hypothesis can be appropriately evaluated even if inference knowledge that does not always hold true is used.

### BRIEF DESCRIPTION OF THE DRAWINGS

FIG. 1 is a block diagram schematically showing a configuration of a abductive inference apparatus in an example embodiment of the invention.

FIG. 2 is a block diagram specifically showing a configuration of the abductive inference apparatus in an example embodiment of the invention.

FIG. 3 is a flowchart showing the overall operations of the abductive inference apparatus in an example embodiment of the invention.

FIG. 4 is a flowchart showing the overall operations of the abductive inference apparatus in an example embodiment of the invention.

FIG. 5 is a block diagram showing an example of a computer that realizes the abductive inference apparatus in an example embodiment of the invention.

FIG. 6 is a diagram showing examples of candidate hypotheses generated in working examples of the invention.

FIG. 7 is a diagram showing examples of candidate hypotheses generated using a conventional method.

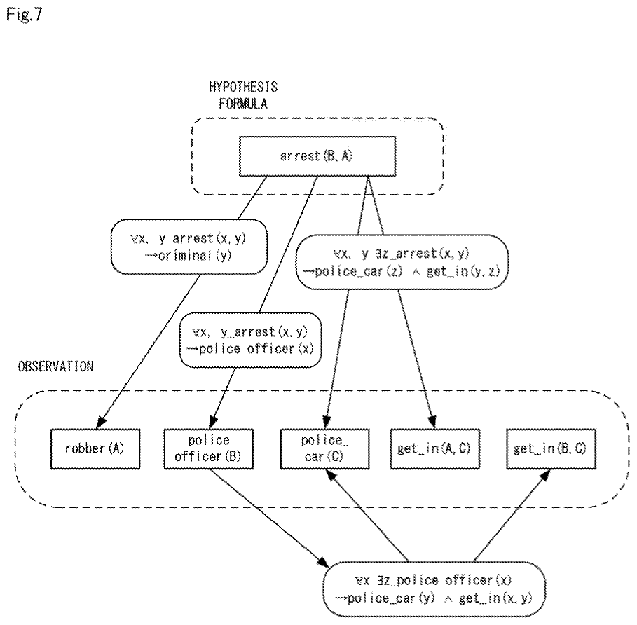

### EXAMPLE EMBODIMENT

### Example Embodiment

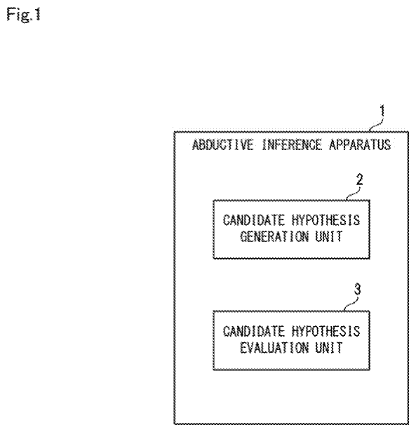

Hereinafter, an abductive inference apparatus, an abductive inference method, and a program according to example embodiments of the invention will be described with reference to FIGS. 1 to 6.

### Apparatus Configuration

First, a configuration of the abductive inference apparatus according to this example embodiment will be described with reference to FIG. 1. FIG. 1 is a block diagram schematically showing the configuration of the abductive inference apparatus according to an example embodiment of the invention.

The abductive inference apparatus 1 of this example embodiment shown in FIG. 1 is an apparatus for applying inference knowledge to an observation that indicates an observed situation using a logical expression, and deriving the most appropriate hypothesis. As shown in FIG. 1, the abductive inference apparatus 1 includes a candidate hypothesis generation unit 2 and a candidate hypothesis evaluation unit 3.

The candidate hypothesis generation unit 2 applies inference knowledge to an observation, makes an inference, and generates candidate hypotheses by which an observation can be derived. Note that inference knowledge used at this time is provided with the reliability for making a forward inference and the reliability for making a reverse inference.

The candidate hypothesis evaluation unit 3 first specifies an inference direction for each piece of the inference knowledge applied to the candidate hypotheses generated by the candidate hypothesis generation unit 2. Then, the candidate hypothesis evaluation unit 3 calculates evaluation values of the candidate hypotheses using the reliability that corresponds to the specified inference direction of each piece of the inference knowledge.

Because inference knowledge is provided with the reliability for making a forward inference and the reliability for making a reverse inference in this manner in this example embodiment, not only a reverse inference but also a forward inference can be made. That is, a forward inference that could not be made through conventional reasoning can be made in this example embodiment. Also, because a forward inference can be made, the probability of a candidate hypothesis can be appropriately evaluated even if inference knowledge that does not always hold true is used.

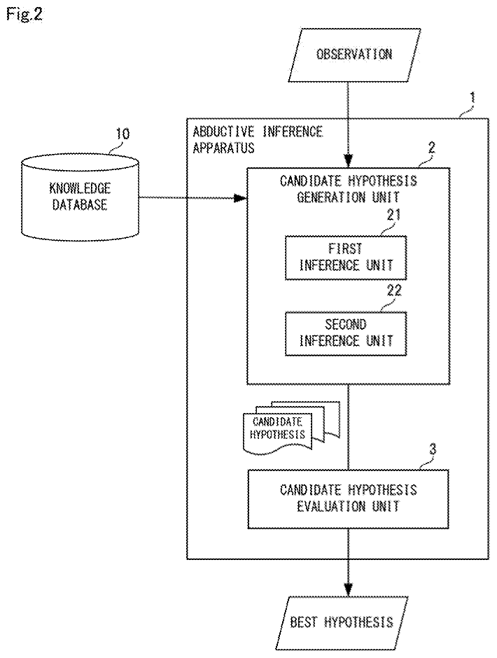

Next, the configuration of the abductive inference apparatus 1 according to this example embodiment will be described in more detail with reference to FIG. 2. FIG. 2 is a block diagram specifically showing a configuration of the abductive inference apparatus according to an example embodiment of the invention.

First, as shown in FIG. 2, in this example embodiment, an observation is input to the abductive inference apparatus 1 from an external terminal apparatus or the like. Also, in this example embodiment, an example of the observation is the conjunction of atomic formulas based on first-order predicate logic, to which real-valued costs are assigned, for example. In this case, a cost quantitatively represents “how deeply observation information needs to be explained”. Specifically, if a cost of 10.0 is assigned to an atomic formula apple(x), an observation is written as “apple(x)^{$10}”.

As shown in FIG. 2, the abductive inference apparatus 1 is connected to a knowledge database 10 in which inference knowledge is stored, in this example embodiment. As described above, the reliability for making a forward inference and the reliability for making a reverse inference are added to pieces of inference knowledge stored in the knowledge database 10.

Here, assume that Pᵢ and Qᵢ are atomic formulas in the first-order predicate logic. Also, assume that a, is a parameter that indicates the likelihood of Pi holding true when the consequent holds true, that is, the reliability for making a reverse inference. Also, assume that bᵢ is a parameter that indicates the likelihood of Qᵢ holding true when the antecedent holds true, that is, the reliability for making a forward inference. In this case, inference knowledge is an implicit-type logical formula, and is expressed using a logical formula in the form represented by Math 1 below. The parameters aᵢ and bᵢ are respectively real numbers.

P₁^{α}^{₁}∧P₂^{α}^{₂}∧ . . . ∧P_{N}^{α}^{_{N}}⇒Q₁^{b}^{₁}∧Q₂^{b}^{₂}∧ . . . ∧Q_{M}^{b}^{_{M}} [Math 1]

In Math 1 above, the summation of weights on one side is a value corresponding to a “probability that this side is deductively derived from the opposite side”. The magnitude of aᵢ and the magnitude of bi are determined according to their importance in the conjunction thereof Also, assume that all variables included in the antecedent of inference knowledge are subjected to universal quantification, and all variables included only in the consequent of inference knowledge are subjected to existential quantification. Hereinafter, even if a quantifier is omitted, variables are subjected to quantification based on such a premise.

Also, as shown in FIG. 2, in this example embodiment, the candidate hypothesis generation unit 2 includes a first inference unit 21 and a second inference unit 22. The first inference unit 21 applies inference knowledge in reverse to an observation and makes an inference. The second inference unit 22 applies forward inference knowledge to an observation and makes an inference. The candidate hypothesis generation unit 2 generates a set of candidate hypotheses using the results of the inference made by the first inference unit 21 and the results of the inference made by the second inference unit 22.

Also, the candidate hypothesis generation unit 2 may generate a plurality of candidate hypothesis for one observation, or generate one or more candidate hypotheses for each of a plurality of observations. The candidate hypothesis generation unit 2 outputs the set of the plurality of generated candidate hypotheses to the candidate hypothesis evaluation unit 3.

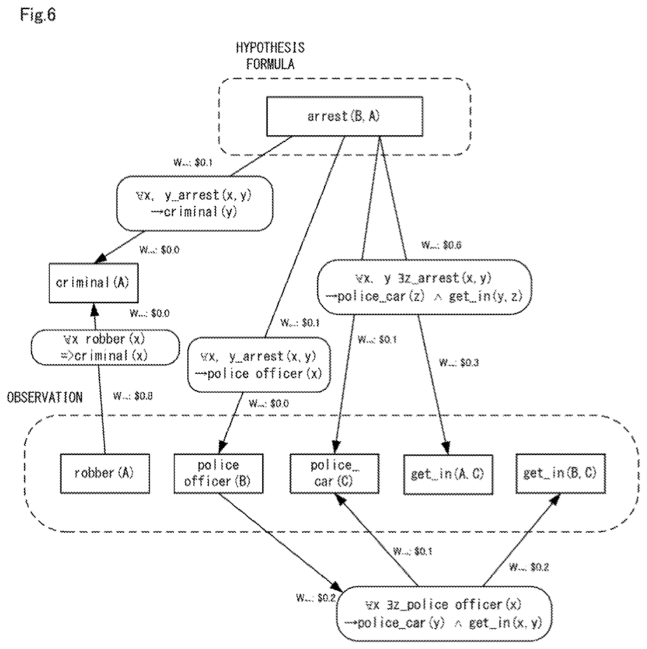

Also, in this example embodiment, candidate hypotheses are indicated using a directed acyclic graph where atomic formulas based on the first-order predicate logic are nodes (see FIG. 6). In a directed acyclic graph indicates, edges connecting nodes indicate to a relationship about “which atomic formula explains which atomic formula using which piece of inference knowledge”. Note that the direction of inference knowledge does not necessarily coincide with the direction of an edge in a directed acyclic graph.

In a directed acyclic graph, a terminal node reached when following the direction of the edges coincides with any one of an atomic formula included in an observation. Also, in a directed acyclic graph, atomic formulas that correspond to nodes that are not explained, that is, nodes that are not the starting points of the edges are referred to as “hypothesis formulas (Hypotheses)”.

In this example embodiment, when the candidate hypothesis evaluation unit 3 first receives the set of candidate hypotheses output from the candidate hypothesis generation unit 2 (see FIG. 6), the candidate hypothesis evaluation unit 3 calculates an evaluation value for each candidate hypothesis. Then, the candidate hypothesis evaluation unit 3 specifies the candidate hypothesis with the highest evaluation value based on the evaluation values of the candidate hypotheses, and determines this candidate hypothesis as the candidate hypothesis for explaining the observation without excess or deficiency, that is, the best hypothesis.

### Apparatus Operations

Next, operations of the abductive inference apparatus 1 in this example embodiment will be described. The following description references FIGS. 1 and 2 as appropriate. Also, in this example embodiment, an abductive inference method is implemented by causing the abductive inference apparatus 1 to operate. Accordingly, the following description of operations of the abductive inference apparatus 1 will substitute for a description of a abductive inference method according to this example embodiment.

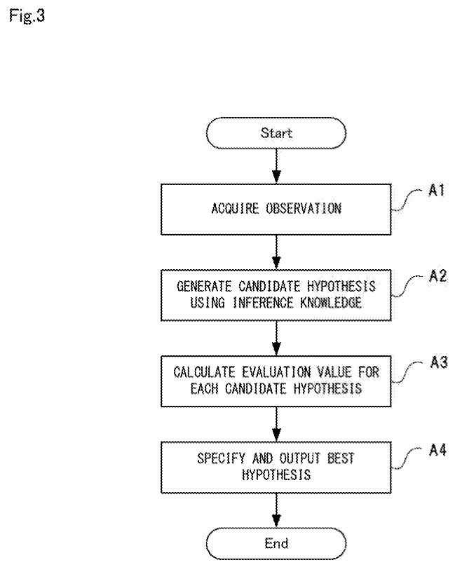

First, the overall operations of the abductive inference apparatus 1 according to this example embodiment will be described with reference to FIG. 3. FIG. 3 is a flowchart showing the overall operations of the abductive inference apparatus in an example embodiment of the invention. As shown in FIG. 3, first, the candidate hypothesis generation unit 2 acquires an observation that is to be subjected to abductive inference, from the outside, for example, a terminal apparatus of a user requiring abductive inference (step A1).

Then, the candidate hypothesis generation unit 2 acquires inference knowledge from the knowledge database 10, applies the acquired inference knowledge to the observation acquired in step A1, makes inferences (a reverse inference and a forward inference), and generates a candidate hypothesis by which the observation can be derived (step A2). Also, the candidate hypothesis generation unit 2 outputs the set of the generated candidate hypotheses to the candidate hypothesis evaluation unit 3.

Then, when the candidate hypothesis evaluation unit 3 receives the set of candidate hypotheses output in step A2, the candidate hypothesis evaluation unit 3 calculates an evaluation value for each candidate hypothesis (step A3).

Specifically, in this example embodiment, an evaluation value that is to be given to a candidate hypothesis indicates whether or not this candidate hypothesis explains an observation without excess or deficiency, using the magnitude of a real number. Thus, the candidate hypothesis evaluation unit 3 determines, for each candidate hypothesis, which piece of inference knowledge is used and how in that candidate hypothesis, and calculates evaluation values based on the results of determination.

The candidate hypothesis evaluation unit 3 calculates an evaluation value for each candidate hypothesis using both “the reliability for making a reverse inference” and “the reliability for making a forward inference” that are added to each piece of inference knowledge, for example. Also, in this example embodiment, because an evaluation value is calculated using these two types of reliability, an appropriate evaluation value can be given to a candidate hypothesis obtained using inference knowledge that does not always hold true.

Then, the candidate hypothesis evaluation unit 3 specifies, as the best hypothesis, the candidate hypothesis with the highest evaluation value based on the evaluation values of the candidate hypotheses, and outputs the specified best hypothesis to the terminal apparatus of the user requiring abductive inference, for example (step A4).

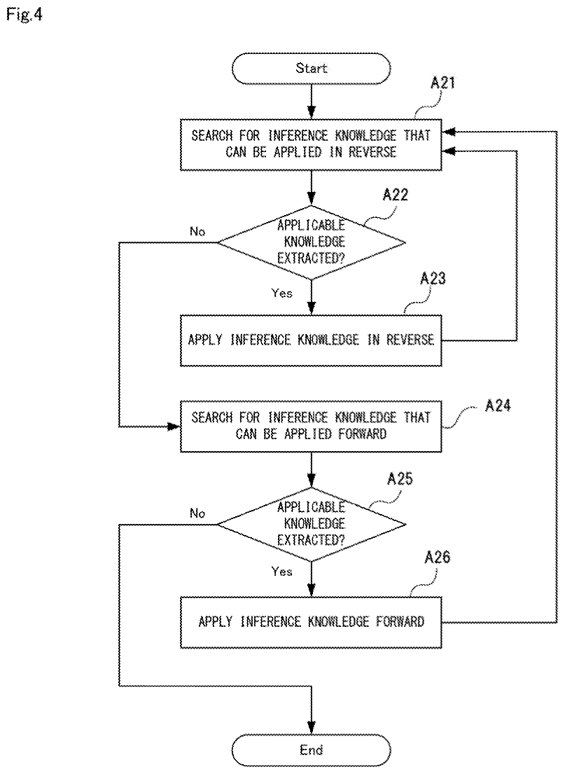

Next, step A2 shown in FIG. 3 will be described in more detail with reference to FIG. 4. FIG. 4 is a flowchart showing the overall operations of the abductive inference apparatus in an example embodiment of the invention.

As shown in FIG. 4, after step A1 is executed, first, the first inference unit 21 searches the knowledge database 10 for inference knowledge that can be applied in reverse to the set of the current candidate hypotheses (step A21). Note that, in a state where a candidate hypothesis has not yet been generated, the set of candidate hypotheses is in the initial state, and includes only an observation. That is, the set of candidate hypotheses in this case include only hypothesis formulas as candidate hypotheses.

Specifically, in step A21, with regard to each piece of inference knowledge, the first inference unit 21 compares, for each candidate hypothesis currently included in the set of candidate hypotheses, an atomic formula included in the candidate hypotheses with an atomic formula included in the consequent of inference knowledge. Then, the first inference unit 21 extracts, based on the comparison results, inference knowledge that allows variable substitution by which the conjunction constituted by atomic formulas included in candidate hypotheses and the consequent are made equivalent to each other.

Inference knowledge p(x)→q(x) can be applied in reverse to a candidate hypothesis H=q(A), and inference knowledge p(x)→r(x) cannot be applied in reverse thereto, for example. Thus, the first inference unit 21 extracts inference knowledge p(x)→q(x) as a result of performing a search.

Then, the first inference unit 21 determines whether or not inference knowledge that can be applied in reverse to all or at least one of the candidate hypotheses was extracted through the search performed in step A21 (step A22).

If, as a result of determination made in step A22, inference knowledge that can be applied in reverse to all or at least one of the candidate hypotheses was not extracted, the first inference unit 21 outputs the set of the current candidate hypotheses to the second inference unit 22 because there is no piece of inference knowledge that can be newly applied in reverse to any one of the candidate hypotheses that are currently included in the set of candidate hypotheses. Accordingly, step A24, which will be described later, is executed.

On the other hand, if, as a result of the determination made in step A22, inference knowledge that can be applied in reverse was extracted, the first inference unit 21 applies the extracted inference knowledge in reverse to an applicable candidate hypothesis (step A23).

A new candidate hypothesis for an observation is generated by executing step A23. If inference knowledge p(x)→q(x) is applied in reverse to the candidate hypothesis H=q(A), for example, a new candidate hypothesis H=q(A)∧p(A) is added to the set of candidate hypotheses. Then, the first inference unit 21 executes step A21 again.

In step A24, the second inference unit 22 searches the knowledge database 10 for inference knowledge that can be applied forward to the set of candidate hypotheses received from the first inference unit 21.

Specifically, similarly to step A21, in step A24, with regard to each piece of inference knowledge, the second inference unit 22 compares, for each candidate hypothesis currently included in the set of candidate hypotheses, an atomic formula included in the candidate hypotheses with an atomic formula included in the antecedent of inference knowledge. Then, the second inference unit 22 extracts, based on the comparison results, inference knowledge that allows variable substitution by which the conjunction constituted by atomic formulas included in candidate hypotheses and the antecedent are made equivalent to each other.

Inference knowledge p(x)→q(x) cannot be applied forward to the candidate hypothesis H=q(A), but inference knowledge q(x)→r(x) can be applied forward thereto, for example. Thus, the second inference unit 22 extracts inference knowledge q(x)→r(x) as a result of performing a search.

Then, the second inference unit 22 determines whether or not inference knowledge that can be applied forward to all or at least one of the candidate hypotheses was extracted through the search performed in step A24 (step A25).

If, as a result of determination made in step A25, inference knowledge that can be applied forward to all or at least one of the candidate hypotheses was not extracted, the second inference unit 22 outputs the set of the current candidate hypotheses to a virtual candidate evaluation unit 3 because there is no piece of inference knowledge that can be newly applied forward to any one of the candidate hypotheses that are currently included in the set of candidate hypotheses. Then, step A3 is executed.

On the other hand, if, as a result of the determination made in step A25, inference knowledge that can be applied forward was extracted, the second inference unit 22 applies the extracted inference knowledge forward to an applicable candidate hypothesis (step A26). Assume that inference knowledge q(x)→r(x) is applied forward to the candidate hypothesis H=q(A), for example. In this case, a new candidate hypothesis H=r(x)∧q(A) is added to the set of candidate hypotheses.

Note that, although processing performed by the first inference unit 21 is executed and then processing performed by the second inference unit 22 is executed in the example shown in FIG. 4, this example embodiment is not limited to this example. In this example embodiment, a configuration may be adopted in which processing performed by the second inference unit 22 is executed and then processing performed by the first inference unit 21 is executed.

### Effects in Embodiment

As described above, according to this example embodiment 1, candidate hypotheses can be generated as a result of making a forward inference that cannot be made using a conventional method, and thus broader matter can be handled, compared with a conventional method.

Also, in this example embodiment, in evaluation of candidate hypotheses, the forward inference reliability of inference knowledge can be taken into account, and thus candidate hypotheses can be more accurately evaluated, compared with a conventional method. As a result, the probability for candidate hypotheses generated using inference knowledge that does not always hold true can be appropriately evaluated, and the accuracy of inference by the abductive inference apparatus 1 can be increased.

### Program

A program according to this example embodiment may be a program for causing a computer to execute steps A1 to A4 shown in FIG. 3. The abductive inference apparatus 1 and the abductive inference method of example embodiments can be realized by installing the program to this computer and executing it. In this case, a CPU (Central Processing Unit) of the computer functions as, and performs processing as, the candidate hypothesis generation unit 2 and the candidate hypothesis evaluation unit 3.

Also, the program of this example embodiment may be executed by a computer system constructed by a plurality of computers. In this case, the computers may each function as any one or more of the candidate hypothesis generation unit 2 and the candidate hypothesis evaluation unit 3, for example.

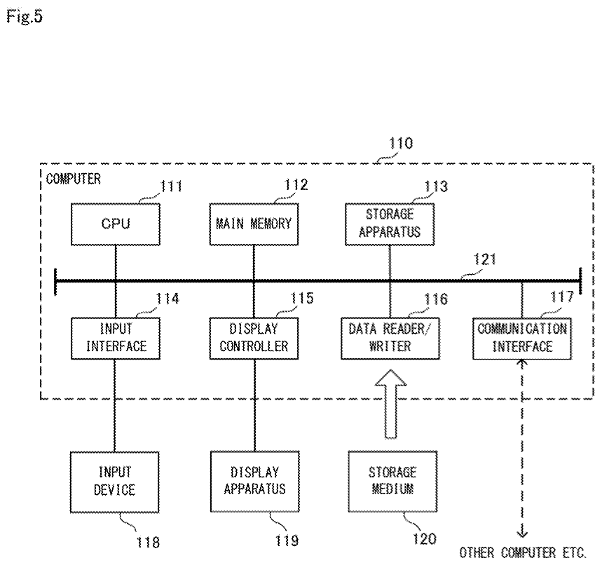

Here, a computer that realizes the abductive inference apparatus 1 by executing the program of this example embodiment will be described with reference to FIG. 4. FIG. 5 is a block diagram showing an example of the computer that realizes the abductive inference apparatus in an example embodiment of the invention.

As shown in FIG. 5, a computer 110 includes a CPU 111, a main memory 112, a storage device 113, an input interface 114, a display controller 115, a data reader/writer 116, and a communication interface 117. These members are connected via a bus 121 to enable the exchange of data therebetween.

The CPU 111 carries out various types of arithmetic calculation by loading the program (codes) of this example embodiment, which is stored in the storage apparatus 113, to the main memory 112 and executing the codes in a predetermined sequence. The main memory 112 is typically a volatile storage apparatus such as a DRAM (Dynamic Random Access Memory). Also, the program of this example embodiment is provided in a state of being stored on a computer readable recording medium 120. Note that the program in this example embodiment may be distributed on the Internet, which can be accessed via the communication interface 117.

Besides a hard disk drive, other examples of the storage apparatus 113 include a semiconductor storage apparatus such as a flash memory. The input interface 114 mediates the transfer of data between the CPU 111 and input devices 118 such as a keyboard and a mouse. The display controller 115 is connected to a display apparatus 119 and controls display performed by the display apparatus 119.

The data reader/writer 116 mediates the transfer of data between the CPU 111 and the recording medium 120, reads out the program from the recording medium 120, and writes processing results obtained by the computer 110 to the recording medium 120. The communication interface 117 mediates the transfer of data between the CPU 111 and other computers.

Also, specific examples of the recording medium 120 include a general-purpose semiconductor storage device such as a CF (Compact Flash (registered trademark)) and an SD (Secure Digital), a magnetic recording medium such as a flexible disk, and an optical recording media such as a CD-ROM (Compact Disk Read Only Memory).

Note that the abductive inference apparatus 1 according to an example embodiment of the invention can also be realized with use of hardware that corresponds to the above-described units, instead of a computer having the program installed therein. Furthermore, a configuration is possible in which one portion of the abductive inference apparatus 1 is realized by a program, and the remaining portion is realized by hardware.

### Working Examples

Here, the invention will be described by way of specific working examples with reference to FIG. 6. FIG. 6 is a diagram showing an example of candidate hypotheses generated in working examples of the invention. In the following description, operations of the abductive inference apparatus 1 in this working example will be described according to the steps shown in FIG. 3.

### Step A1

First, the candidate hypothesis generation unit 2 acquires, from a user terminal apparatus, as an observation, the conjunction “robber(A)∧police officer(B)∧police car(C)∧get in(A,C)∧get in(B,C)” in which observation information “Robber A and Police officer B are in the same police car C” is expressed using a logical expression (see FIG. 6).

Also, real-valued costs are assigned to individual atomic formulas included in the observation, the real-valued costs each indicating how much this atomic formula needs to be explained. Here, assume a case where a constant cost of 0.0 is given to all atomic formulas in the observation, as the simplest definition.

### Step A2

Assume that “if x is a robber, then x is a criminal”, “if x arrests y, then y is a criminal”, “if x arrests y, then x is a police officer”, “if x arrests y, then y gets in a police car”, and “if x is a police officer, then x gets in a police car” are stored in the knowledge database 10 as inference knowledge serving as background knowledge.

Also, as shown in FIG. 6, individual pieces of inference knowledge included in the knowledge database 10 are actually expressed using a logical expression. Also, inference knowledge is provided with a value corresponding to the reliability for making a forward inference and a value corresponding to the reliability for making a reverse inference. In this working example, as the simplest definition, inference knowledge P→Q is provided with a probability p(Q|P) as the forward inference reliability, and is provided with a probability p(P|Q) as the reverse inference reliability.

The reliability added to each piece of inference knowledge shown in FIG. 6 is as follows, for example.
∀x, y arrest(x,y)^{0.9}→criminal(y)^{1.0}
∀x, y arrest(x,y)^{0.9}→police officer(x)^{1.0}
∀x robber(x)^{0.2}→criminal(x)^{1.0}
∀x, y ∃z arrest(x,y)^{0.4}→police car(z)^{0.9}∧get in(y,z)^{0.7}
∀x ∃y police officer(x)^{0.8}→police car(y)^{0.9}∧get in(x,y)^{0.8}

The candidate hypothesis generation unit 2 generates a set of candidate hypotheses using the observation and inference knowledge stored in the knowledge database 10. Note that the set of candidate hypotheses include only the observation in the initial state. That is, in the initial state, the observation “robber(A)∧police officer(B)∧police car(C)∧get in(A,C)∧get in(B,C)” is present as one candidate hypothesis.

Specifically, the first inference unit 21 searches the knowledge database 10 for inference knowledge that can be applied in reverse to the set of candidate hypotheses. If x=B, y=A, and z=C are substituted into the inference knowledge “∀x, y ∃z arrest(x,y)→police car(z)∧get in(y,z)”, for example, the consequent of this piece of inference knowledge coincides with a portion of the observation. Thus, the first inference unit 21 determines that this piece of inference knowledge can be applied in reverse, and extracts this piece of inference knowledge.

Also, the first inference unit 21 applies the extracted inference knowledge in reverse to each of the candidate hypotheses that are currently included in the set of candidate hypotheses. The inference knowledge “∀x, y ∃z arrest(x,y)→police car(z)∧get in(y,z)” is applied to the above-described initial state (observation) of the set of candidate hypotheses, for example. In this case, the conjunction “police car(C)∧get in(A,C)” included in the observation and the inference knowledge “∃x arrest(x,A)” are equivalent to each other due to variable substitution, and thus this hypothesis holds true. Thus, “∃x arrest(x,A)∧robber(A)∧police officer(B)∧police car(C)∧get in(A,C)∧get in(B,C)” is added as a new candidate hypothesis to the set of candidate hypotheses.

Incidentally, usually, in abductive inference, candidate hypotheses include a pair of atomic formulas that are identical to each other as a result of substituting another variable for a variable that has been subjected to existential quantification, a candidate hypothesis obtained through such variable substitution is generated separately.

Assume that the inference knowledge “∀x, y arrest(x,y)→police officer(x)” and the inference knowledge “∀x, y ∃z arrest(x,y)→police car(z)∧get in(y,z)” are applied in reverse to the above-described observation, for example. In this case, “∃x,y arrest(B,y)∧arrest(x,A)∧robber(A)∧police officer(B)∧police car(C)∧get in(A,C)∧get in(B,C)” is generated as a candidate hypothesis.

Here, when x is equal to B and y is equal to A (x=B and y=A), the atomic formulas “arrest(B,y)” and “arrest(x,A)” in the candidate hypothesis are the same formula. Thus, the candidate hypothesis “arrest(x,A)∧robber(A)∧police officer(B)∧police car(C)∧get in(A,C)∧get in(B,C)” obtained when such variable substitution is performed is also added to the set of candidate hypotheses. Hereinafter, such a procedure is referred to as a “unification operation (Unification)”.

Also, the second inference unit 22 searches for inference knowledge through the same procedure as that of the first inference unit 21. Because the inference knowledge “∀x robber(x)→criminal(x)” coincides with the atomic formula “robber(A)” included in the observation in the antecedent through substitution of x=A, for example, the second inference unit 22 extracts this inference knowledge as inference knowledge that can be applied forward.

Then, the second inference unit 22 applies the extracted inference knowledge forward to each of the candidate hypotheses that are currently included in the set of candidate hypotheses. The inference knowledge “∀x robber(x,y)→criminal(x)” is applied to the above-described initial state (observation) of the set of candidate hypotheses, for example. In this case, the second inference unit 22 generates “criminal(A)∧robber(A)∧police officer(B)∧police car(C)∧get in(A,C)∧get in(B,C)” as a new candidate hypothesis, and adds the generated new candidate hypothesis to the set of candidate hypotheses. Note that, similarly to the first inference unit 21, the second inference unit 22 also executes a unification.

If both the first inference unit 21 and the second inference unit 22 cannot extract inference knowledge that can be newly applied, generation of a candidate hypothesis is complete.

### Step A3

Next, when the candidate hypothesis evaluation unit 3 receives, as input, the set of candidate hypotheses output from the candidate hypothesis generation unit 2, the candidate hypothesis evaluation unit 3 calculates evaluation values of the candidate hypotheses in order to output, as the best hypothesis, a candidate hypothesis that is evaluated as the best explanation in the set of candidate hypotheses.

Specifically, the candidate hypothesis evaluation unit 3 calculates an evaluation value for each of the candidate hypotheses using both “the reliability for making a reverse inference” and “the reliability for making a forward inference” that are added to each piece of inference knowledge. Also, a higher evaluation value is assigned to a candidate hypothesis in which an observation can be explained without excess or deficiency. Math 2 below is conceivable as an equation for calculating an evaluation value for a candidate hypothesis H, for example.

$$eval ( H ) = {\sum }_{a ∈ B ( H )} {w}_{\to } ( a ) + {\sum }_{h ∈ hyp ( H )} {min}_{B ∈ path ( h )} {\sum }_{a ∈ B} {w}_{←} ( a ) \qquad [ Math 2 ]$$

In Math 2 above, B(H) is a set of pieces of inference knowledge used in a candidate hypothesis. hyp(H) is a set of atomic formulas included in a hypothesis formula in the candidate hypothesis. path(H) is a function for returning the set of pieces of inference knowledge used in each path starting from the atomic formula x to any one of the observations, as a set thereof for each path.

W_{←}(a) is a function of returning a value obtained by subtracting the reverse inference reliability of the inference knowledge a from 1.0 when inference knowledge a is applied forward, and returning a value obtained by subtracting the forward inference reliability of the inference knowledge a from 1.0 when the inference knowledge a is applied in reverse.

W_{→}(a) is a function of returning a value obtained by subtracting the forward inference reliability of the inference knowledge a from 1.0 when inference knowledge a is applied forward, and returning a value obtained by subtracting the reverse inference reliability of the inference knowledge a from 1.0 when the inference knowledge a is applied in reverse.

In Math 2 above, the first term evaluates the likelihood that an observation can be explained from a hypothesis formula. Also, the second term evaluates the likelihood that a hypothesis formula can be presumed from an observation. Thus, in the case of the candidate hypotheses shown in FIG. 6, the values W are as shown in FIG. 6, for example, and thus the first term is {0.8+0.1+0.2+0.1+0.3}, and the second term is min(0.1, (0.1+0.2), 0.6)=0.1. Thus, the evaluation value for the candidate hypotheses shown in FIG. 6 is {0.8+(0.1+0.2)+(0.1+0.3)}+0.1=1.6.

### Step A4

Next, the candidate hypothesis evaluation unit 3 selects a candidate hypothesis with the highest evaluation value from the candidate hypotheses included in the set of candidate hypotheses. Note that the method disclosed in Non-Patent Document 1 may be used as a selection method. Non-Patent Document 1 proposes a method for deriving the best hypothesis at a high speed as a result of expressing a procedure for selecting the best hypothesis as an equivalent integer linear programming problem, and solving this problem using an external integer linear programming problem solver.

As described above, in this working example, inference knowledge is provided with the reliability for making a forward inference and the reliability for making a reverse inference, and thus not only a reverse inference but also a forward inference are made. That is, a forward inference that could not be made through conventional reasoning can be made in this example embodiment. Also, because a forward inference can be made, the probability of a candidate hypothesis can be appropriately evaluated even if inference knowledge that does not always hold true is used.

The example embodiments described above can be partially or entirely realized by Supplementary Notes 1 to 6 listed below, but the invention is not limited to the following descriptions.

### Supplementary Note 1

An abductive inference apparatus including:
a candidate hypothesis generation unit configured to apply, to an observation that indicates an observed situation using a logical expression, inference knowledge provided with reliability for making a forward inference and reliability for making a reverse inference, make an inference, and generate a candidate hypothesis by which the observation can be derived; and
a candidate hypothesis evaluation unit configured to specify an inference direction for each piece of the inference knowledge applied to the generated candidate hypothesis, and calculate an evaluation value of the candidate hypothesis using the reliability of each piece of the inference knowledge that corresponds to the specified inference direction.

### Supplementary Note 2

The abductive inference apparatus according to Supplementary Note 1,
wherein the candidate hypothesis generation unit includes:
   a first inference unit configured to apply the inference knowledge in reverse to the observation and make an inference; and
   a second inference unit configured to apply the inference knowledge forward to the observation and make an inference, and
   the candidate hypothesis is generated using a result of the inference made by the first inference unit and a result of the inference made by the second inference unit.

### Supplementary Note 3

An abductive inference method including:
(a) a step of applying, to an observation that indicates an observed situation using a logical expression, inference knowledge provided with reliability for making a forward inference and reliability for making a reverse inference, making an inference, and generating a candidate hypothesis by which the observation can be derived; and
(b) a step of specifying an inference direction for each piece of the inference knowledge applied to the generated candidate hypothesis, and calculating an evaluation value of the candidate hypothesis using the reliability of each piece of the inference knowledge that corresponds to the specified inference direction.

### Supplementary Note 4

The abductive inference method according to Supplementary Note 3,
wherein the (a) step includes:
   (a1) a step of applying the inference knowledge in reverse to the observation and making an inference;
   (a2) a step of applying the inference knowledge forward to the observation and making an inference; and
   (a3) a step of generating the candidate hypothesis using a result of the inference made in the (a1) step and a result of the inference made in the (a2) step.

### Supplementary Note 5

A computer-readable recording medium that includes a program recorded thereon, the program including instructions that cause a computer to carry out:
(a) a step of applying, to an observation that indicates an observed situation using a logical expression, inference knowledge provided with reliability for making a forward inference and reliability for making a reverse inference, making an inference, and generating a candidate hypothesis by which the observation can be derived; and
(b) a step of specifying an inference direction for each piece of the inference knowledge applied to the generated candidate hypothesis, and calculating an evaluation value of the candidate hypothesis using the reliability of each piece of the inference knowledge that corresponds to the specified inference direction.

### Supplementary Note 6

The computer-readable recording medium according to Supplementary Note 5,
wherein the (a) step includes:
   (a1) a step of applying the inference knowledge in reverse to the observation and making an inference;
   (a2) a step of applying the inference knowledge forward to the observation and making an inference; and
   (a3) a step of generating the candidate hypothesis using a result of the inference made in the (a1) step and a result of the inference made in the (a2) step.

### INDUSTRIAL APPLICABILITY

As described above, according to the invention, a forward inference can be made, and the probability of a candidate hypothesis can be appropriately evaluated even in a case where inference knowledge that does not always hold true is used. The invention is applicable to applications such as generation of an explanation and understanding of a situation using background knowledge and observation information. More specifically, the invention is useful for automated systems that perform medical, legal consultation, risk detection, and the like.

### REFERENCE NUMERALS

1 Abductive inference apparatus
2 Candidate hypothesis generation unit
3 Candidate hypothesis evaluation unit
10 Knowledge database
21 First inference unit
22 Second inference unit
110 Computer
111 CPU
112 Main memory
113 Storage apparatus
114 Input interface
115 Display controller
116 Data reader/writer
117 Communication interface
118 Input device
119 Display apparatus
120 Recording medium
121 Bus

1. An abductive inference apparatus comprising:
a candidate hypothesis generation unit configured to apply, to an observation that indicates an observed situation using a logical expression, inference knowledge provided with reliability for making a forward inference and reliability for making a reverse inference, make an inference, and generate a candidate hypothesis by which the observation can be derived; and
a candidate hypothesis evaluation unit configured to specify an inference direction for each piece of the inference knowledge applied to the generated candidate hypothesis, and calculate an evaluation value of the candidate hypothesis using the reliability of each piece of the inference knowledge that corresponds to the specified inference direction.

2. The abductive inference apparatus according to claim 1,
wherein the candidate hypothesis generation unit includes:
a first inference unit configured to apply the inference knowledge in reverse to the observation and make an inference; and
a second inference unit configured to apply the inference knowledge forward to the observation and make an inference, and
the candidate hypothesis is generated using a result of the inference made by the first inference unit and a result of the inference made by the second inference unit.

3. An abductive inference method comprising:
(a) applying, to an observation that indicates an observed situation using a logical expression, inference knowledge provided with reliability for making a forward inference and reliability for making a reverse inference, making an inference, and generating a candidate hypothesis by which the observation can be derived; and
(b) of specifying an inference direction for each piece of the inference knowledge applied to the generated candidate hypothesis, and calculating an evaluation value of the candidate hypothesis using the reliability of each piece of the inference knowledge that corresponds to the specified inference direction.

4. The abductive inference method according to claim 3,
wherein the (a) includes:
(a1) applying the inference knowledge in reverse to the observation and making an inference;
(a2) applying the inference knowledge forward to the observation and making an inference; and
(a3) generating the candidate hypothesis using a result of the inference made in the (a1) and a result of the inference made in the (a2).

5. A non-transitory computer-readable recording medium that includes a program recorded thereon, the program including instructions that cause a computer to carry out:
(a) a step of applying, to an observation that indicates an observed situation using a logical expression, inference knowledge provided with reliability for making a forward inference and reliability for making a reverse inference, making an inference, and generating a candidate hypothesis by which the observation can be derived; and
(b) a step of specifying an inference direction for each piece of the inference knowledge applied to the generated candidate hypothesis, and calculating an evaluation value of the candidate hypothesis using the reliability of each piece of the inference knowledge that corresponds to the specified inference direction.

6. The non-transitory computer-readable recording medium according to claim 5,
wherein the (a) step includes:
(a1) a step of applying the inference knowledge in reverse to the observation and making an inference;
(a2) a step of applying the inference knowledge forward to the observation and making an inference; and
(a3) a step of generating the candidate hypothesis using a result of the inference made in the (a1) step and a result of the inference made in the (a2) step.
